(19) United States
(12) Patent Application Publication
(10) Pub. No.: US 2010/0019618 A1
(43) Pub. Date: Jan. 28, 2010

(54) TRANSVERSAL QUANTUM HEAT CONVERTER

(76) Inventors: Eliade Stefanescu, Bucharest (RO); Lucien Eugene Cornescu, Bucharest 2 (RO)

Correspondence Address: GRIFFIN & SZIPL, PC, SUITE PH-1, 2300 NINTH STREET, SOUTH, ARLINGTON, VA, 22204, US

(21) Appl. No.: 11/773,850

(22) Filed: Jul. 5, 2007

(51) Int. Cl. H02N 10/00

(52) U.S. Cl. 310/306

(57) ABSTRACT

A semiconductor device is disclosed for environment heat conversion in coherent electromagnetic energy by a super radiant quantum decay and a thermal excitation of a system of electrons in a super lattice of n-i-p-n transistors with quantum dots on the two sides of the i-layer, and potential barriers for separating the quantum transition n-i-p regions from the adjacent conduction n and p regions. When an electron current is injected in a perpendicular direction on the transistor arrays, a super radiant field is generated in the plane of these arrays, with a power mainly obtained by a heat absorption that is much larger than the absorbed electric power. The device also includes an input heat absorber, and an output Fabry-Perot resonator with total transmission for the electromagnetic energy extraction from the device active region.

The present application is related to co-pending U.S. patent application Ser. No. ______, filed on Jul. 5, 2007, and titled “Longitudinal Quantum Heat Converter,” and to co-pending U.S. patent application Ser. No. ______, filed on Jul. 5, 2007, and titled “Quantum Injection System.” The entire disclosures of the above patent applications are hereby incorporated by reference.

### FIELD OF INVENTION

The present invention generally concerns a quantum heat converter for producing coherent electromagnetic energy on the account of the environmental heat. More particularly, the invention refers to a method and a quantum device converting heat in usable coherent electromagnetic energy by super radiant transitions supplied by an injection of electrons.

### BACKGROUND OF THE INVENTION

First of all, if one considers the growing needs nowadays for new sources of energy and more especially of clean and renewable energies, as well as cooling issues for the planet, new solutions have to be developed. Many efforts have been recently done in connection with energies such as solar radiation, hydraulic power of tides or wind, etc. Nevertheless, all these energies require huge installations such as fields of solar panels or wind turbines or hydroelectric power stations and long distribution networks. Furthermore, the amount of energy produced is very low in comparison to the efforts and means needed.

There is a well-known prior art method for converting the solar radiation in electric power by the absorption of this radiation in the internal field of a semiconductor p-i-n junction that separates the generated electric charges as described for example in the prior publication U.S. Pat. No. 4,765,845. The devices built on the basis of this method, usually named solar cells, are semiconductor p-i-n diodes with a system of electrodes optimizing the radiation penetration in the semiconductor volume and the charge collection from this volume. However, the efficiency of this method is rather low, especially for three main reasons: (1) only a narrow part of the incident radiation spectrum is converted into energy, this conversion being based on a quasi-resonant effect of transitions between the margins of the conduction bands stimulated by light, (2) the efficient absorption region, that is restricted to the internal field zone of a semiconductor junction, is rather narrow, an important part of the incident field being lost in the neighbouring neutral zones of the device that do not produce any conversion of radiation into electric power, and (3) the excited charges, electrons and holes coexisting in the same semiconductor region, have large wave-function overlaps, leading to strong dissipative couplings between the charge carriers, and between these the carriers and the crystal lattice.

Alternative solutions based on quantum phenomena for producing energy are currently considered. The approach is based on a quantum theory of open systems, taking into account the energy exchange between a system of fermions and its environment in full agreement with the quantum mechanical and detailed balance conditions detailed in the prior publication in the name of E. Stefanescu, entitled “Dynamics of Fermi system with tunnelling dissipation and dynamical detailed balance” in Physica A 350 (2005, pages 227-244), which is incorporated herein by reference.

The dynamics of such a system interacting with an environment of other fermions, bosons and the free electromagnetic field is described by the quantum master equation:

$$\frac{d }{d t} ρ ( t ) = - \frac{i}{ℏ} [ H , ρ ( t ) ] + {\sum }_{i , j = 1}^{N} {λ}_{ij} ( \begin{matrix}[ {c}_{i}^{+} {c}_{j} ρ ( t ) , {c}_{j}^{+} {c}_{i} ] + \\ [ {c}_{i}^{+} {c}_{j} , ρ ( t ) {c}_{j}^{+} {c}_{i} ]\end{matrix} ) \qquad ( 1 )$$

with the Hamiltonian of the dissipative system

H=Σᵢεᵢcᵢ⁺cᵢ (2)

and the N²−1 explicit dissipation coefficients for an N-level system of the form:

λᵢⱼ=λᵢⱼ^{F}+λᵢⱼ^{B}+γᵢⱼ. (3)

These coefficients depend on the dissipative two-body potentials V^{F} and V^{B} of interaction with the environment fermions and respectively bosons, the densities of the environment states g_{α}^{F}, g_{α}^{B} environment fermions and respectively bosons, and the occupation probabilities of these states f_{α}^{F}, f_{α}^{B} depending on temperature T in the agreement with the detailed balance principle exposed in the abovementioned publication “Dynamics of Fermi system with tunnelling dissipation and dynamical detailed balance”. For a rather low temperature, T<<εⱼᵢ where j>i, the dissipative coefficients are of the form:

$$\begin{matrix}{λ}_{ij}^{F} = \frac{π}{ℏ} {\vert 〈 α i \vert {V}^{F} \vert β j 〉 \vert}^{2} [ 1 - {f}_{α}^{F} ( {ɛ}_{ji} ) ] {g}_{α}^{F} ( {ɛ}_{ji} ) & ( 4 a ) \\ {λ}_{ji}^{F} = \frac{π}{ℏ} {\vert 〈 α i \vert {V}^{F} \vert β j 〉 \vert}^{2} {f}_{α}^{F} ( {ɛ}_{ji} ) {g}_{α}^{F} ( {ɛ}_{ji} ) , & ( 4 b )\end{matrix}$$

for the Fermi environment,

$$\begin{matrix}{λ}_{ij}^{B} = \frac{π}{ℏ} {\vert 〈 α i \vert {V}^{B} \vert β j 〉 \vert}^{2} [ 1 + {f}_{α}^{B} ( {ɛ}_{ji} ) ] {g}_{α}^{B} ( {ɛ}_{ji} ) & ( 5 a ) \\ {λ}_{ji}^{B} = \frac{π}{ℏ} {\vert 〈 α i \vert {V}^{B} \vert β j 〉 \vert}^{2} {f}_{α}^{B} ( {ɛ}_{ji} ) {g}_{α}^{B} ( {ɛ}_{ji} ) & ( 5 b )\end{matrix}$$

for the Bose environment, and

$${λ}_{ij} = \frac{2 α}{{c}^{2} {ℏ}^{3}} {\overline{r}}_{ij}^{2} {ɛ}_{ji}^{3} ( 1 + \frac{1}{{e}^{{ɛ}_{ji / T}} - 1} ) \qquad ( 6 )$$

for the free electromagnetic field, where \vec{r}ᵢⱼ is the dipole moment and

$$α = \frac{{e}^{2}}{4 π ɛ ℏ c } \approx \frac{1}{137} \vert .$$

In this framework, the problem of converting the environment heat into coherent usable energy has been considered, taking into account the complete set of characteristics of the active system and of a complex dissipative environment. On this basis, a semiconductor device for converting a heat flow into super radiant power has been proposed in a prior publication, also incorporated herein by reference, in the name of E. Stefabescu and W. Scheid, entitled “Superradiant dissipative tunnelling in a double p-i-n semiconductor heterostructure with thermal injection of electrons” in Physica A 374 (2007, pages 203-210).

The operation of this device is essentially based on the quantum nature of the active system. In a classical system, a usable kinetic energy can be obtained by decay from a higher potential to a lower one as, for instance, it is the case of the water decay in a hydroelectric plant represented in FIGS. 1a and 1b. In this case, the kinetic energy Eₖ results from the difference between the initial potential energy U and the final potential energy U₀, minus an always present energy loss U_{L}. The energy Eₖ obtained from a flow between two potential energies U and U₀ is the same, no matter that this flow is a monotonic one with three steps 1-2-3 as represented in FIG. 1a, or has a much lower intermediate potential value U₁ with five steps 1-2-3-4-5 as showed in FIG. 1b.

### SUMMARY OF THE INVENTION

The main goal of the invention is to provide a new system for producing clean and renewable energy which avoids afore cited drawbacks of the prior art solutions. According to the present invention, a much more efficient quantum effect is carried out converting heat into usable coherent electromagnetic energy or electric energy.

For that purpose, the invention concerns a method for producing in a semiconductor device coherent electromagnetic energy on the account of an environmental heat by an electron flow between an initial potential and a lower final potential, comprising the two steps:

(i) a super radiant quantum decay of electrons to an intermediate potential that is lower than both the initial and the final potentials, where the super radiant quantum decay is coupled to an electromagnetic field mode propagating in a perpendicular direction to the electron flow through the semiconductor device
(ii) a thermal excitation of electrons from the intermediate potential to the final potential by taking energy from an internal field region of the semiconductor device recovering this energy by heat absorption from the environment.

Thus, a somehow similar method for producing energy as the one presented in FIG. 1b is implemented, but of a quantum nature, where an electron decay from an initial energy level to an intermediate energy level is coupled with a super radiant mode of the electromagnetic field, while the excitation from the intermediate energy level to the final one is provided by heat absorption in an internal field region. In this way, the radiated power, corresponding to the decay from the initial energy level to the intermediate energy level, is much larger than the absorbed electric power, the difference being provided by heat absorption.

According to another aspect, the invention concerns a transversal quantum heat converter for environmental heat conversion into coherent electromagnetic energy, comprising at least one n-i-p-n structure with quantum dots on both sides of the i-layer, a metal front electrode and a rear electrode of the n-i-p-n structure, a heat absorber in thermal contact with the metal front electrode, a first and a second mirror perpendicular to the electrodes, both mirrors forming an active cavity with the n-i-p-n structure in-between, and a third external mirror defining a transmission output cavity with the second mirror.

According to an advantageous variant, the n-i-p-n structure with quantum dots forms a super radiant transistor, the p-region being much narrower than the electron diffusion length, thus enabling the diffusion of these electrons from the n-i emitter region mainly to the collector p-n internal field region.

According to an advantageous variant, the first n and the p regions of the n-i-p-n structure form two conduction regions, and wherein the quantum dots and the i-layer form an active quantum dot region which is separated from the two conduction regions by potential barriers, to diminish the dissipative coupling of the active electrons with the electrons in the conduction regions.

According to an advantageous variant, the potential barriers have rather high penetrability to enable quantum tunnelling between the active quantum dot region and the conduction regions.

According to an advantageous variant, the active cavity comprises several n-i-p-n structures connected in series.

According to another aspect, the invention concerns a super radiant semiconductor device with a super lattice of super radiant transistors enclosed in a cavity selecting a super radiant mode propagating in the plan of the transistors, i.e. transversal to the heat propagation. Thus, in a transversal quantum heat converter, the resonance mode is transversal to the laser cavity where the electrons are propagating. It is an advantageous solution since there are no losses of electric energy in the optical terminal, which is different from the electrical one.

According to another aspect, the invention concerns a transversal quantum heat converter with thermal injection of electrons composed of two transversal quantum heat converters, electrically connected in ring, where one of the two transversal quantum heat converters is the load of the other and conversely, and optically paralleled, with the two n-emitters in thermal contact with a common heat absorber at a higher temperature and the two n-collectors in thermal contact with a heat radiator at a lower temperature, emitting two parallel electromagnetic beams by heat absorption from the environment. Such a solution is particularly adapted for environment which presents two different environmental temperatures. For instance, it may happen when the converter, or any of its possible support, is used in the cosmos, i.e. space, where one side will be exposed to the sun and the opposite side will remain in the dark. It may also happen when the converter or any of its possible support is placed in between two different middles, for example one side being in the air while the opposite side is immerged in water.

According to another aspect, the invention concerns a transversal quantum heat converter with auto injection for environmental heat conversion into coherent electromagnetic energy, comprising one transversal quantum heat converter, optically and electrically coupled with a quantum injection system wherein the coherent electromagnetic energy is partially used for generating injection current that is necessary to the transversal quantum heat converter operation.

According to another aspect, the invention concerns a quantum photo-electric converter for converting a coherent electromagnetic energy into electric energy by quasi-resonant transitions between bound quantum states, comprising at least one p-i-n structure with quantum dots on each side of the i-layer defining a quantum dot region, and potential barriers to separate this quantum dot region from the conduction p and n regions.

According to another aspect, the invention concerns a quantum thermoelectric converter for the environmental heat into electric energy comprising a transversal quantum heat converter with auto injection, and a quantum photo-electric converter for converting a coherent electromagnetic energy into electric energy by quasi-resonant transitions between bound quantum states, comprising at least one p-i-n structure with quantum dots on each side of the i-layer defining a quantum dot region, and potential barriers to separate this quantum dot region from the conduction p and n regions.

According to another aspect, the invention concerns a quantum thermoelectric converter for the environmental heat into electric energy comprising a transversal quantum heat converter with thermal injection of electrons, and a quantum photo-electric converter for converting a coherent electromagnetic energy into electric energy by quasi-resonant transitions between bound quantum states, comprising at least one p-i-n structure with quantum dots on each side of the i-layer defining a quantum dot region, and potential barriers to separate this quantum dot region from the conduction p and n regions.

According to another aspect, the invention concerns a quantum thermoelectric converter for the environmental heat into electric energy comprising a transversal quantum heat converter for environmental heat conversion into coherent electromagnetic energy, comprising at least one n-i-p-n structure with quantum dots on both sides of the i-layer, a metal front electrode and a rear electrode of the n-i-p-n structure, a heat absorber in thermal contact with the metal front electrode, a first and a second mirror perpendicular to the electrodes, both mirrors forming an active cavity with the n-i-p-n structure in-between, and a third external mirror defining a transmission output cavity with the second mirror, and a quantum photo-electric converter for converting a coherent electromagnetic power into electric power by quasi-resonant transitions between bound quantum states, as a super lattice of p-i-n diodes with quantum dots at the interfaces of the i-layer and separation barriers of the quantum dot region from the conduction p and n regions.

According to another aspect, the invention concerns a transversal quantum heat converter for environmental heat conversion into coherent electromagnetic energy, comprising at least one n-i-p-n structure including a first n-i-p junction and a second p-n junction, a metal front electrode and a rear electrode of the n-i-p-n structure, a heat absorber in thermal contact with the metal front electrode of the n-i-p-n structure, a first and a second mirror perpendicular to the front electrode, both mirrors forming an active cavity with the n-i-p-n structure in-between, and a third external mirror defining a transmission output cavity with the second mirror.

According to another aspect, the invention concerns a transversal quantum heat converter for environmental heat conversion into coherent electromagnetic energy, comprising an active cavity with at least one n-i-p-n structure inside, a heat absorber in thermal contact with the active cavity, and a transmission output cavity for extracting electromagnetic energy from the active cavity.

According to another aspect, the invention concerns a power supply comprising a heat converter according to any of the preceding aspects.

According to another aspect, the invention concerns a generator comprising a heat converter according to any of the preceding aspects.

According to another aspect, the invention concerns an integrated circuit comprising a heat converter, power supply or generator according to any other preceding aspects.

According to another aspect, the invention also concerns a microchip comprising a heat converter, power supply, generator, or integrated circuit according to any preceding aspects.

### BRIEF DESCRIPTION OF THE DRAWINGS

Other features and advantages of the invention will appear upon reading the following description which refers to the annexed drawings in which:

FIGS. 1a and 1b represent a classical system for energy production by a liquid decay that is the same either for a monotonic decay as in 1a) or for a flow in two main steps as in 1b);

FIG. 2 represents a transversal quantum heat converter according to a first embodiment of the present invention, based on an electron flow in two steps, a super radiant decay and a thermal excitation;

FIG. 3 is a symbolic representation of the transversal quantum heat converter of FIG. 2;

FIG. 4 is a symbolic representation of a transversal quantum heat converter with thermal injection of electrons according to a second embodiment of the present invention;

FIG. 5, is a symbolic representation of a transversal quantum heat converter with auto-injection according to a third embodiment of the present invention;

FIG. 6 represents a quantum photo-electric converter according to another aspect of the present invention;

FIG. 7 is a representation of a symbol of a quantum photo-electric converter of FIG. 6;

FIG. 8 is a symbolic representation of a quantum thermoelectric converter according to another aspect of the present invention.

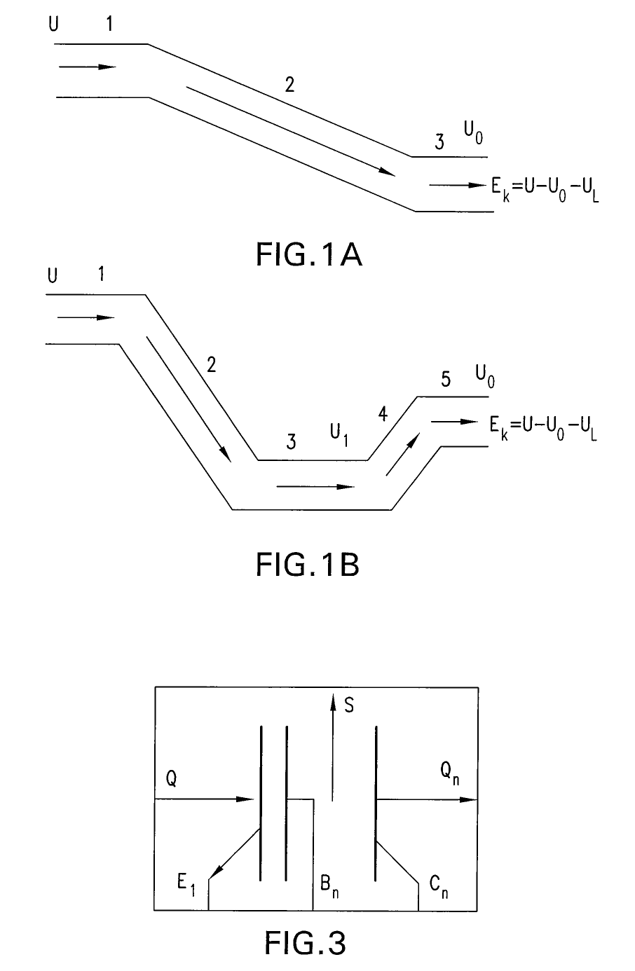

### DETAILED DESCRIPTION OF THE INVENTION

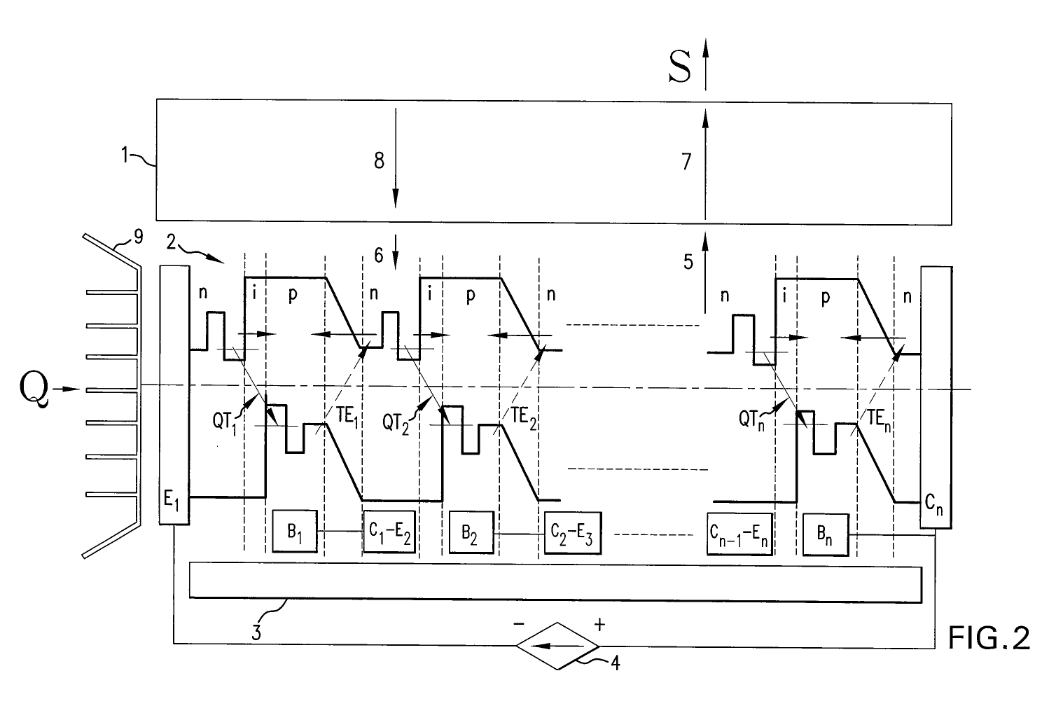

The present invention consists in a method and a semiconductor device for the coherent electromagnetic energy production on the account of the environment energy, by an electron transfer in two steps: (1) a super radiant decay, and (2) a thermal excitation. These method and semiconductor device will now be detailed only by way of non limiting examples in relation with FIGS. 2 to 8.

The following description discloses an alternate version of the co-pending application Ser. No. “B-16581” entitled “Longitudinal quantum heat converter”, which is incorporated herein by reference.

In this co-pending application, by quantum transitions between quantum dots in a super radiant transistor array, a heat flow absorbed in a perpendicular direction to this array is partially transformed into a super radiant energy flow propagating in the same direction. The transition dipole moment generating the super radiant field, that is perpendicular to the propagation direction, is a matrix element between quasi-free states of electrons moving inside the two parallel quantum dot arrays.

In the present invention, the effects of these thermal fluctuations on the super radiant field are avoided by coupling the quantum transitions to a super radiant mode propagating in the plan of the transistor arrays. In this way the dipole moment generating the super radiant field is a matrix element between bound states, defined on the coordinate perpendicular to the transistor arrays.

Referring now to FIG. 2, which represents a transversal quantum heat converter according to a first aspect of the present invention, the semiconductor structure 2 is included in a Fabry-Perot resonator between another Fabry-Perot resonator 1 and the mirror 3. An electron current is injected in the device by the current supply 4.

The active volume is a series circuit of n-i-p-n super radiant transistors, where the collector C₁, of the first transistor is connected to the emitter E₂ of the second transistor, C₂ is connected to E₃, . . . Cₙ₋₁ is connected to Eₙ. Every transistor has the base connected to its collector: B₁ to C₁, B₂ to C₂, . . . Bₙ to Cₙ. In this case, a current amplification is still present, that means that the majority of the electrons injected from emitter to base are directed to collector, being carried by the internal field of the collector-base junction. These electrons get energy from the internal electric field that is diminished, while the corresponding spatial charge region is lessened and the temperature is lowered. By heat absorption Q by the heat absorber 9, an additional diffusion current is generated, while the spatial charge region and the corresponding internal field are remade. That means that the electron path in a series circuit of the super radiant transistors includes the super radiant quantum transitions QT₁, QT₂, . . . QTₙ, and thermal excitations TE₁, TE₂, . . . TEₙ.

A super radiant field with the forward wave 5 and a counter-propagating wave 6 is generated in the perfectly tuned Fabry-Perot between the mirror 3 and the Fabry-Perot resonator 1. The Fabry-Perot resonator 1 having mirrors with equal transmission coefficients T, forms the waves 7 and 8 with the amplitudes

$${ɛ}_{7} = \frac{1}{𝒯} {ɛ}_{5} \vert$$

and respectively

$${ɛ}_{8} = - \frac{ℛ}{𝒯} {ɛ}_{5} ,$$

and the transmitted wave S with the amplitude ε_{S}=ε₅, while the amplitude of the reflected wave 6 becomes ε₆=0. Thus, the electromagnetic energy generated in the active volume 2 is totally extracted outside.

FIG. 3 is a symbolic representation of the transversal quantum heat converter of FIG. 2 that will be used farther in the present specification for sake of simplicity. On this symbolic representation, there are the thermal terminals Q and Qₙ, the electrical terminals E₁, Bₙ, Cₙ, and the optical terminal S.

According to a first variant of the transversal quantum heat converter above described in relation with FIGS. 2 and 3, a transversal quantum heat converter with thermal injection of electrons comprises a system of two transversal quantum heat converters of the type represented in FIG. 3, converting a heat flow, between a heat absorber placed at a higher temperature and a heat radiator placed at a lower temperature, in coherent electromagnetic power. The electron current generated by thermoelectric effect in one device is looped with the other device, the thermoelectric voltages generated by the two devices being summed-up in the serial electric circuit of the two devices. The radiation direction of the device is perpendicular to the heat flow direction. The invention also concerns a similar converter with n>2 transversal quantum heat converters electrically connected in a ring, the total thermally generated voltage in this ring being equal to the voltage generated in one converter multiplied by the number of these converters.

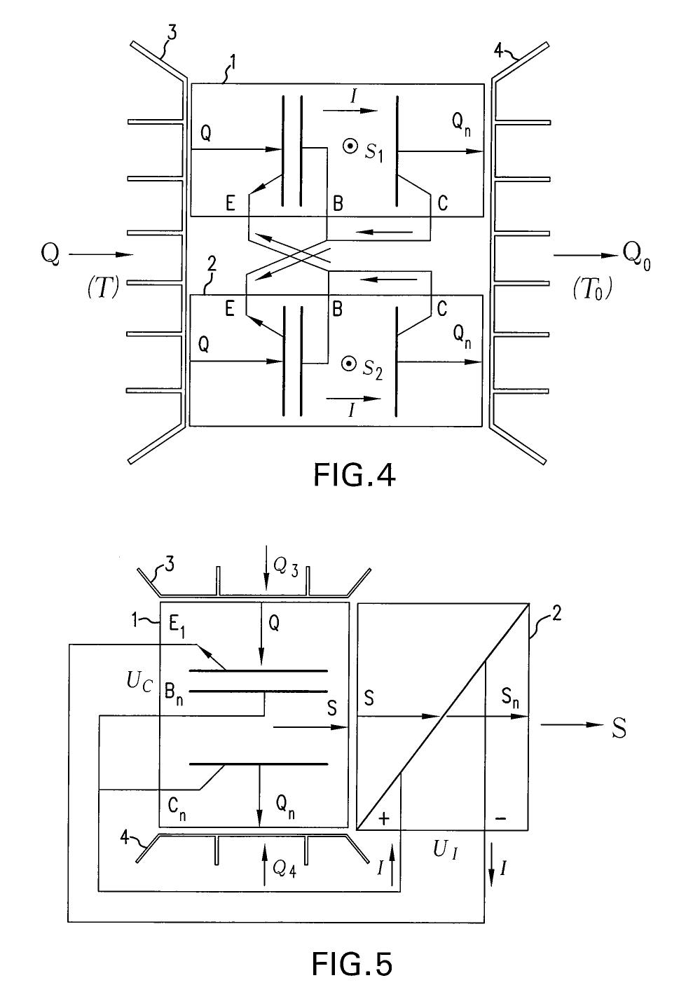

Considering now FIG. 4, which represents a transversal quantum heat converter with thermal injection of electrons according to this first variant, the two transversal quantum heat converters 1 and 2 are placed in a thermal field between temperature T of the heat absorber 3 and temperature TO of the heat radiator 4. Corresponding to this temperature difference, the following internal voltage is generated:

$$U = \frac{{T}_{1}}{e} ln \frac{{N}_{c} ( {T}_{1} )}{{N}_{D}} - \frac{{T}_{0}}{e} ln \frac{{N}_{c} ( {T}_{0} )}{{N}_{D}} \vert$$

$$where$$

$${N}_{c} ( T ) = 2 {( \frac{\sqrt{{M}_{n} T / 2 π}}{ℏ} )}^{3}$$

is a coefficient depending on temperature T expressed in energy units, the effective mass Mₙ of the electron in the n region of the emitter/collector of the device, and the donor concentration N_{D} that is supposed to be the same in the emitter and in the collector.

Under this voltage, an electric current I is generated in the device. When this current exceeds a certain threshold value I₀, the super radiant electromagnetic flows S₁ and S₂ are generated by the transversal quantum heat converters 1 and respectively 2.

As above described in relation with the first aspect, a heat absorbed from the environment is partially converted into super radiant power when an electron current is injected in the semiconductor device, the absorbed electric power being much lesser than the super radiant power. When using a quantum injection system as described in the co-pending application Ser No “B-16583” entitled “quantum injection system”, which is incorporated herein by reference, a coherent electromagnetic energy flow can be partially transformed into an injected current at a voltage that can be matched with the polarization voltage of the transversal quantum heat converter.

In this case, the majority of the injection current necessary to obtain coherent energy is obtained by thermoelectric effect, while the internal field region, giving energy to the electrons coming from the base of the structure, becomes colder. This is because an internal field region is an effect of equilibrium between the diffusion and field currents existing at the boundaries of this region. An increase of the field current coming from base is cancelled by an additional diffusion current coming from collector, which means heat absorption. In other words, the energy got by the electrons crossing the internal field region is of thermal origin.

An internal field region defines a coupling between the electrons coming in this region and the thermal environment, which means that the electrons crossing such a region get energy from this environment. The quantum injection system is necessary only to inject the necessary current since the initial moment until the device reaches the stationary regime, and further only to cancel the energy losses of the current circulation from the collector potential to the emitter potential. These losses are much lesser than the production of coherent electromagnetic energy corresponding to the super radiant decay from emitter to base.

For that purpose, a second advantageous variant of transversal quantum heat converter concerns a super radiant system composed of a transversal quantum heat converter as described in relation with FIG. 2 and a quantum injection system with the same proper voltage as disclosed in the above mentioned co-pending application. Thus while the heat absorbed by the system is converted into coherent electromagnetic energy, a part of this energy is used for providing the necessary injection current for the device operation.

FIG. 5 is a symbolic representation of a transversal quantum heat converter with auto injection. It consists in a system composed of a transversal quantum heat converter 1, and a quantum injection system 2. The necessary polarization current is provided by converting into electric power a part of the radiated electromagnetic power.

Getting now into details of FIG. 5, the transversal quantum heat converter 1 with the two thermal terminals Q, Qₙ in intimate contact with the heat absorbers 3 and 4 is optically coupled with the quantum injection system 2. The polarization voltage U_{C} of the quantum heat converter 1 and the polarization voltage U_{I} of the quantum heat injector 2 being matched, when these two devices are electrically coupled the operation injection current I is provided. While an electromagnetic power flow is generated by the device 1 on the account of the heat flows Q₃ and Q₄ provided by the heat absorbers 3 and respectively 4, a little part of this power is transformed into electric power by the device 2, the most part S remaining available as an useful power.

As already seen with the different variants of quantum heat converters, a coherent electromagnetic field is generated by absorbing heat from the environment. With an active Fabry-Perot transmitter or a quantum injection device as detailed in the co-pending application Ser No “B-16583” entitled “Quantum injection system”, a little part of the power of a coherent electromagnetic beam that is crossing the device is converted into electric power. According to a second aspect, the present invention concerns a semiconductor device for the total conversion of a coherent electromagnetic energy flow into electric power.

For that purpose, the second aspect concerns a semiconductor device transforming the energy of a coherent electromagnetic beam into electric energy, as a super lattice of p-i-n diodes with resonant quantum injection of electrons between quantum dot arrays situated on the two sides of the i-region. While the electrons are injected from the anode quantum dots to the cathode quantum dots by resonant absorption, these electrons undertake a dissipative decay in the cathode conduction region, further recombining with the holes diffusing from the anode p-region of the following diode that is directly polarized, or being carried to the rear electrode. The device also includes a front electrode system as a resonant Fabry-Perot cavity with total transmission for capturing the incident beam, and a rear metal electrode.

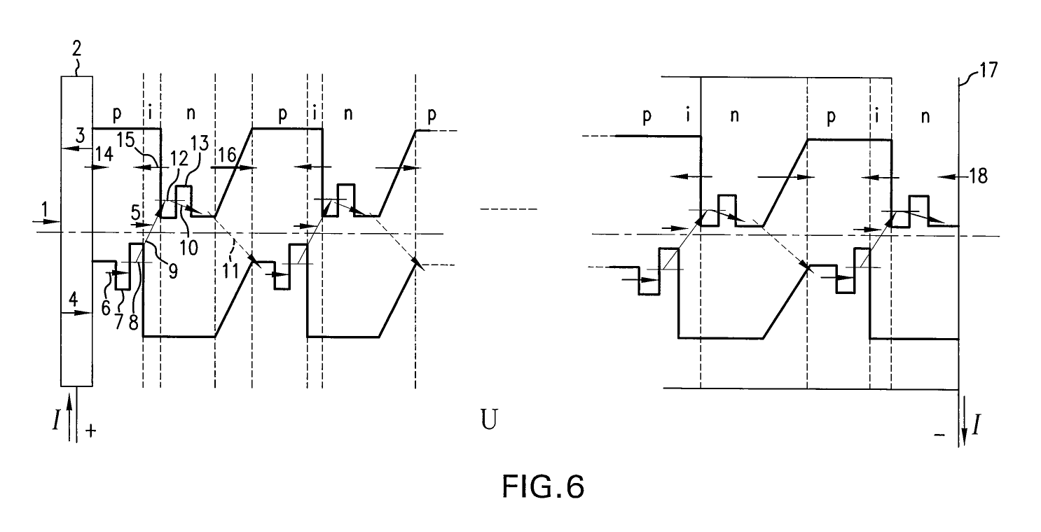

FIG. 6 represents a quantum photo-electric converter according to the second aspect of the present invention. An input coherent electromagnetic wave 1 with the amplitude ε₁ is coupled to the passive Fabry-Perot resonator 2 where the counter-propagating waves 3 and 4 are generated, while a wave 5 with an amplitude ε₅≈ε₁ is injected in the active zone, inducing quasi-resonant transitions 9 between the energy levels 8 and 12. From the higher levels 12, the electrons undertake a dissipative tunnelling 10 through the separation barriers 13 to the n conduction regions, by direct polarization of the n-p junctions undertaking an injection 11 from a p-i-n diode to the following p-i-n diode. By dissipative tunnelling processes 6 the electrons penetrate the barriers 7 to the lower levels 8 of the optical transitions 9. By the quasi-resonant absorption of the field in the active region between the passive Fabry-Perot resonator 2 and the electrode 17, an electron current I is generated at a voltage U determined by the variations of the internal fields 14, 15, 16, . . . 18.

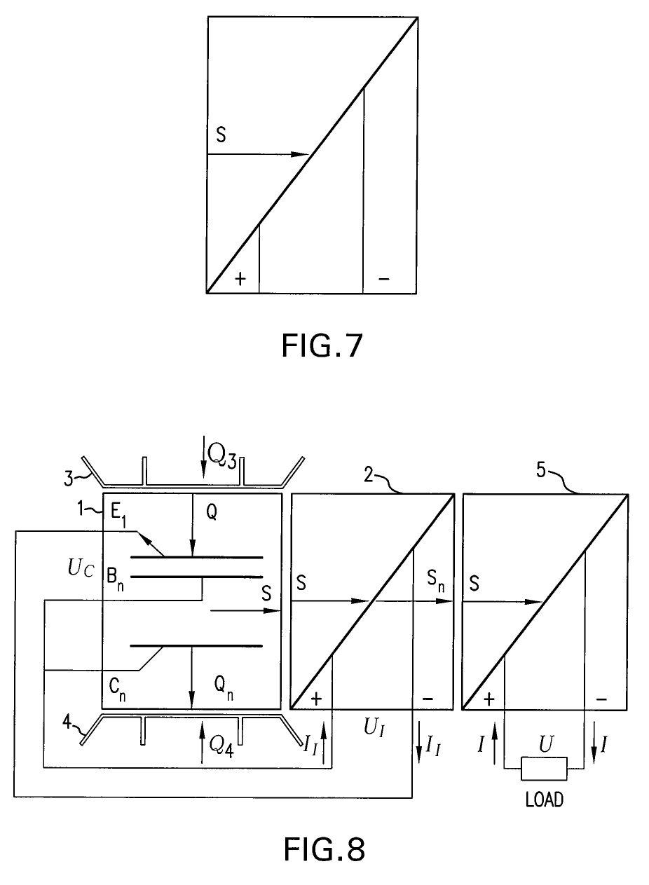

FIG. 7 represents a symbol of a quantum photo-electric converter of FIG. 6, with an optical terminal S for the input electromagnetic power and two electric terminals +,− for the output electric power.

Advantageously in order to obtain a constant current flowing through the whole structure with several p-i-n semiconductor devices, the dipole moment dl in the first structure p-i-n determines the current/by the radiation of S₁ coming on the first junction 9. Then the radiation of S₂ which is lower than S₁ arrives at the second junction and the dipole moment should therefore be chosen to imply the same current I. For having the same current, the dipole moment in the second structure has to be increased since the electromagnetic field S decreases. For that purpose, either the width of the intermediate region may be reduced, or the potential barrier of each structure p-i-n may be reduced.

A third aspect of the present invention concerns an electric supply taking energy from the environment, composed of a transversal quantum heat converter with auto injection as described in relation with FIG. 5 and a quantum photo-electric converter as described in relation with FIGS. 6 and 7. The environmental heat is converted into electric energy in two steps: (1) a heat conversion into coherent electromagnetic energy, and (2) a coherent electromagnetic energy conversion into electric energy.

FIG. 8 represents such a quantum thermoelectric converter. A heat flow Q₃+Q₄ absorbed from the environment is partially converted into an electric power U_{I}·I_{I} necessary for the device operation, the remaining part being converted into a usable electric power U·I.

The transversal quantum heat converter 1 with the polarization voltage U_{C} is polarized with the necessary operation current I_{I} by the quantum injection system 2 with approximately the same polarization voltage U_{I}≈U_{C}. The heat flows Q₃ and Q₄ provided by the heat absorbers 3 and 4 are converted by the converter 1 into an electromagnetic energy flow that is partially converted by the injection system 2 into the necessary polarization power U_{I}·I_{I}. The remaining electromagnetic energy flow, after transversally crossing the injection system 2, is converted by the quantum photo-electric converter 5 into electric power, providing an electron current I at the characteristic voltage U to a LOAD.

It is to note that preferably the load voltage is not used for the current injection because the load has first to be separated from the generator and second it may be different according to the application and as such cannot be used trustfully for supplying the converter. For that reason, either auto injection from the Fabry-Perot cavity or temperature difference may be used to provide the current supply.

Having described the invention with regard to certain specific embodiments, it is to be understood that these embodiments are not meant as limitations of the invention. Indeed, various modifications, adaptations and/or combination between embodiments may become apparent to those skilled in the art without departing from the scope of the annexed claims.

For instance, at the end of the active cavity or laser cavity, the last junction p-n could be alternatively replaced either with a n semiconductor or directly with a metal plate which behaves like a n semiconductor.

According to an advantageous embodiment applicable to any of the previous aspects of the invention, it is provided that a first cavity is defined between both front and rear electrodes and a second cavity, so-called transversal cavity, selecting the transversal super radiant mode of the super radiant electromagnetic field propagating in a perpendicular direction to the electron flow through n-i-p-n structures, this transversal super radiant mode being extracted outside by the transmission cavity. Therefore in this case while extracting transversal modes, the longitudinal modes propagating between the two electrodes are not suitable, and should be somehow rejected by lowering the effect of standing waves. For that purpose, the first cavity has an overall length equal to an integer number of times of the wavelength of the super radiant field. It is also provided that advantageously each i-layer of the n-i-p-n structures are spaced from the front electrode, and preferably also from the rear one, by an integer number of the wavelength of the super radiant electromagnetic field.

Otherwise the above description refers only to n-i-p-n semiconductor structures; nevertheless, it is understandable that p-i-n-p semiconductor structures might be used even if such structures present many defects notably in terms of mobility of electrons in the p-regions which is too slow and in terms of the overall size of the semiconductor structure since the p-regions have to be much larger in comparison with the n-regions of an n-i-p-n structure.

1. A method for producing in a semiconductor device coherent electromagnetic energy on account of environmental heat by an electron flow between an initial potential and a lower final potential, the method comprising the steps of:
(a) providing a super radiant quantum decay of electrons to an intermediate potential that is much lower than both the initial and the final potentials, where the super radiant quantum decay is coupled to an electromagnetic field mode propagating in a perpendicular direction to the electron flow through the semiconductor device; and
(b) generating a thermal excitation of electrons from the intermediate potential to the final potential by taking energy from an internal field region of the semiconductor device and recovering this energy by heat absorption from the environment.

2. The method of claim 1, further comprising an additional step for extracting electromagnetic energy generated inside the semiconductor device through an output resonant cavity with total transmission.

3. The method of claim 2, wherein a current generated during the thermal excitation step by a thermoelectric effect is injected in the semiconductor device.

4. A semiconductor device for the heat conversion into coherent electromagnetic energy according to claim 3.

5. A transversal quantum heat converter for environmental heat conversion into coherent electromagnetic energy, comprising:
(a) at least one n-i-p-n structure with quantum dots on both sides of the i-layer;
(b)-a metal front electrode and a rear electrode of the n-i-p-n structure;
(c) heat absorber in thermal contact with the metal front electrode;
(d) a first mirror and a second mirror perpendicular to the electrodes, both mirrors forming an active cavity with the n-i-p-n structure in-between; and
(e) a third external mirror defining a transmission output cavity with the second mirror.

6. The converter of claim 5, wherein the n-i-p-n structure with quantum dots forms a super radiant transistor, the p-region being much narrower than the electron diffusion length.

7. The converter of claim 5, wherein the n-i-p-n structure with quantum dots forms a super radiant transistor with an n-emitter, a p-base and an n-collector.

8. The converter of claim 5, wherein the first n region and the p region of the n-i-p-n structure form two conduction regions, and wherein the quantum dots and the i-layer form an active quantum dot region that is separated from the two conduction regions by potential barriers.

9. The converter of claim 8, wherein the potential barriers have rather high penetrabilities to enable quantum tunnelling between the active quantum dot region and the conduction regions.

10. The converter of claim 5, wherein the second mirror and the third mirror are semitransparent with the same coefficient of transparency.

11. The converter of claim 8, wherein the active quantum dot region has two different energy levels defining a super radiant transition frequency, and wherein the first mirror and the second mirror form a Fabry-Perot cavity tuned with the super radiant transition frequency.

12. The converter of claim 5, wherein the third external mirror has a transmission coefficient equal to the transmission coefficient of the second mirror, both the third external mirror and the second mirror forming a total transmission resonant cavity.

13. The converter of claim 5, wherein the active cavity comprises several n-i-p-n structures connected in series.

14. The converter of claim 6, wherein the n-i-p-n structure has an active region contained in the active cavity selecting a super radiant mode that propagates in the plan of the super radiant transistor.

15. The converter of claim 14, wherein the super radiant transistors are collector-base short circuited and are connected in a series circuit.

16. The converter of claim 15, wherein the emitter of the first transistor is in thermal contact with a heat absorber providing a temperature field decreasing with depth.

17. The converter of claim 5, wherein the rear electrode is a metal electrode in thermal contact with a second heat absorber.

18. A transversal quantum heat converter with thermal injection of electrons composed of two transversal quantum heat converters of claim 5, electrically connected in a ring, where one of the two transversal quantum heat converters is the load of the other and conversely, and optically paralleled, with the two n-emitters in thermal contact with a common heat absorber at a higher temperatures and the two n-collectors are in thermal contact with a heat radiator at a lower temperature, emitting two parallel electromagnetic beams by heat absorption from the environment.

19. A transversal quantum heat converter with auto injection for environmental heat conversion into coherent electromagnetic energy, comprising.
(a) one transversal quantum heat converter of claim 5, optically and electrically coupled with a quantum injection system wherein coherent electromagnetic energy is partially used for generating injection current that is necessary to the transversal quantum heat converter operation.

20. A quantum photo-electric converter for converting a coherent electromagnetic energy into electric energy by quasi-resonant transitions between bound quantum states, the converter comprising:
(a) at least one p-i-n structure with quantum dots on each side of the i-layer defining a quantum dot region; and
(b) potential barriers to separate the quantum dot region from the conduction p and n regions.

21. The quantum photo-electric converter of claim 20, comprising a super lattice of p-i-n structures.

22. The quantum photo-electric converter of claim 21, wherein the super-lattice of p-i-n structures is an active medium of a Fabry-Perot resonator.

23. The quantum photo-electric converter of claim 21, wherein a dipole moment of each p-i-n structure is increased compared to a dipole moment of the previous p-i-n structure so that every p-i-n structures injects the same current.

24. A quantum thermoelectric converter for the environmental heat into electric energy, comprising:
(a) the transversal quantum heat converter with auto injection of claim 19; and
(b) a quantum photo-electric converter for converting a coherent electromagnetic energy into electric energy by quasi-resonant transitions between bound quantum states, the quantum photo-electric converter comprising
i. at least one p-i-n structure with quantum dots on each side of the i-layer defining a quantum dot region; and
ii. potential barriers to separate the quantum dot region from the conduction p and n regions.

25. A quantum thermoelectric converter for the environmental heat into electric energy, comprising;
(a) a transversal quantum heat converter with thermal injection of electrons of claim 18; and
(b) a quantum photo-electric converter for converting a coherent electromagnetic energy into electric energy by quasi-resonant transitions between bound quantum states, the quantum photo-electric converter comprising
i. at least one p-i-n structure with quantum dots on each side of the i-layer defining a quantum dot region; and
ii. potential barriers to separate the quantum dot region from the conduction p and n regions.

26. A quantum thermoelectric converter for the environmental heat into electric energy, comprising:
(a) a transversal quantum heat converter for environmental heat conversion into coherent electromagnetic energy, comprising
i. at least one n-i-p-n structure with quantum dots on both sides of the i-layer;
ii. a metal front electrode and a rear electrode of the n-i-p-n structure;
iii. a heat absorber in thermal contact with the metal front electrode;
iv. a first mirror and a second mirror perpendicular to the electrodes, both mirrors forming an active cavity with the n-i-p-n structure in-between; and
v. a third external mirror defining a transmission output cavity with the second mirror; and
(b) a quantum photo-electric converter for converting a coherent electromagnetic power into electric power by quasi-resonant transitions between bound quantum states, the quantum photo-electric converter comprising as a super lattice of p-i-n diodes with quantum dots at the interfaces of the i-layer and separation barriers of the quantum dot region from the conduction p and n regions.

27. A transversal quantum heat converter for environmental heat conversion into coherent electromagnetic energy, comprising:
(a) at least one n-i-p-n structure including a first n-i-p junction and a second p-n junction;
(b) a metal front electrode and a rear electrode of the n-i-p-n structure;
(c) a heat absorber in thermal contact with the metal front electrode of the n-i-p-n structure;
(d) a first mirror and a second mirror perpendicular to the front electrode, both mirrors forming an active cavity with the n-i-p-n structure in-between; and
(e) a third external mirror defining a transmission output cavity with the second mirror.

28. The converter of claim 27, wherein electrons crossing the first n-i-p junction by super radiant quantum decay are injected by transistor effect in the second p-n junction.

29. A transversal quantum heat converter for environmental heat conversion into coherent electromagnetic energy, comprising:
(a) an active cavity with at least one n-i-p-n structure inside;
(b) a heat absorber in thermal contact with the active cavity; and
(c) a transmission output cavity for extracting electromagnetic energy from the active cavity.

30. A generator comprising a transversal quantum heat converter according to claim 5.

31. A power supply comprising a quantum thermoelectric converter according to claim 26.

32. A generator comprising a quantum longitudinal heat converter according to claim 5.

33. A generator comprising a quantum thermoelectric converter according to claim 24.

34. A generator comprising a quantum thermoelectric converter according to claim 25.

35. A generator comprising a quantum thermoelectric converter according to claim 26.

36. An integrated circuit comprising a quantum longitudinal heat converter according to claim 5.

37. An integrated circuit comprising a quantum thermoelectric converter according to claim 24.

38. A microchip comprising a quantum longitudinal heat converter according to claim 5.

39. A microchip comprising a quantum thermoelectric converter according to claim 24.

40. The converter of claim 13, wherein a super radiant electromagnetic field propagates in a perpendicular direction to the electron flow through the n-i-p-n structures, and wherein each i-layer of the n-i-p-n structures are spaced from the front electrode by an integer number of the wavelength of the super radiant electromagnetic field.

41. A method and semiconductor n-i-p-n device according to claim 4, absorbing energy from the environment in the internal filed of the p-n semiconductor junction that becomes colder by transferring field energy to an electron flow that is injected by thermoelectric effect in the super radiant p-i-n junction.
